(19) United States
(12) Patent Application Publication
(10) Pub. No.: US 2007/0220530 A1
(43) Pub. Date: Sep. 20, 2007

(54) Power management architectures

(75) Inventor: Kuang Hsun Hsieh, Taipei City (TW)

Correspondence Address: BIRCH STEWART KOLASCH & BIRCH, PO BOX 747, FALLS CHURCH, VA, 22040-0747, US

(73) Assignee: Accton Technology Corporation

(21) Appl. No.: 11/366,473

(22) Filed: Mar. 3, 2006

(51) Int. Cl. G06F 9/44

(52) U.S. Cl. 719/327

(57) ABSTRACT

The present invention discloses a power management architecture, the present invention comprises a user spacer located over a Kernel space, wherein the user space includes a PM (power management) aware application over a PM library having a PM manager; and the Kernel space having an interface over an APM daemon and device drivers, the APM daemon including a policy engine, a hardware located under the APM daemon and the device drivers.

### FIELD OF THE INVENTION

The present invention relates generally to the power management of a device□and more particularly to a architecture for power management for portable device.

### BACKGROUND OF THE INVENTION

Following with the age of technology and information, people's living relies on science and technology more and more deeply. Especially, the finding of the electricity brings human much convenience. Nowadays, our world is rife with a lot of electric appliances. Ex., a heating, an alarm clock, a microwave oven, and so on. The influence of the electricity on people's life is self-evident.

According to human's dependence on electric devices, advanced technology comes up. This advanced technology is the portable technology. Such as: a cell phone, a PDA (Personal Digital Assistant), or a laptop. These portable devices own a mutual feature is handy for using and easy for carrying. Along with the compactness and portability of the portable technology, people acquire incredible efficiency. And the portable technology is gradually becoming embedded in human beings.

In order to conserve electricity or to extend battery life, various power-saving methods are used. These may include monitor timeouts, hard disk spin downs, and the entry of a “sleep” state. On certain processor systems, it is also possible to adjust the operating clock frequency, or internal operating voltage. For many of the typical applications, a CPU running at a reduced speed is usually not incurring any inconvenience to the user.

Consequently, people invest painstaking effort in the growth of the portable technology. One of the kernel points of this kind technology's development is saving the power failure for prolonging the hours of the power. This method of power management may identify the power mode and decide a suitable power policy. The user could moderate the toting burden of charging apparatus and the frequency of electrifying by means of power management.

One common need of most computer peripherals is electrical power. Management of power in systems is important to avoid the system to fail. To allow peripheral device may work as much freedom as possible, it would be desirable to provide the power saving policy or method to save more power for the portable device. However, the electrical power must be supplied without harming the ordinary operation of the palm-sized computer system.

In view of these virtues, the present invention provides a preferred architecture and mechanism for power management.

### SUMMARY OF THE INVENTION

The present invention provides a power management mechanism and architecture adaptable to a portable device, especially, to the device having WiFi module.

One aspect of the present invention is to disclose a power management architecture, the present invention comprises a user spacer located over a Kernel space, wherein the user space includes a PM (power management) aware application over a PM library having a PM manager; and the Kernel space having an interface over an APM daemon and device drivers, the APM daemon including a policy engine, a hardware located under the APM daemon and the device drivers.

The aforesaid interface is provided to add/remove/modify a power policy and to modify platform's operating mode and power parameters of the platform. In the present invention, APM daemon is run as a kernel space daemon to receive the user space application commands to change system power mode and the APM daemon provides the kernel API interface for the device drivers to register for power mode managing. The policy engine is run in the kernel space and the policy engine monitors system loading periodically and changes system performance dynamically. The aforementioned PM manager is implemented as a user space daemon, and provides a communication interface to let the user space application to register. A DCL (device control layer) provides APIs set to simply the applications communicate with the PM manager. The PM aware application is provide to register itself to the PM manager and responds to system suspend request from the PM manager.

Another aspect of the present invention is to disclose a power management mode mechanism comprising: a first charging mode employed when a battery of a portable device is exhausted. A second charging mode is employed when a battery of a portable device is low but not exhausted. A power down mode is capable of transiting form/to the first charging mode. A second power down mode is capable of transiting form/to the first charging mode and transit form/to the second charging mode. A high speed mode is provided that is capable to transit from/to a low speed mode, the high speed mode is capable to transit from/to the second charging mode, the low speed mode is capable to transit to the second charging mode. An idle mode is capable to transit from/to the low speed mode and to the second charging mode.

A deep sleep mode is provided to transit from the idle mode and to the second charging mode. A power saving mode is capable of transiting from the idle, the deep sleep mode, the high or low speed mode and to the second charging mode, wherein the power saving is also capable of transiting to the second charging mode.

The CPU and SDRAM are operated with the high speed mode during the first charging mode while the WiFi module is off during the first charging mode. The speed of the CPU is transited from the high speed mode to the low speed mode during the second charging mode. The CPU and the SDRAM are operated with the low speed mode during the idle mode while the WiFi module is at the power saving mode.

The CPU is under suspended and the SDRAM is under self-refresh during the deep sleep mode, the WiFi module is under the power saving mode.

The CPU is informed to force power mode to be transited to the power saving mode during the idle, low speed or high speed mode if the battery is almost exhausted. Alternatively, the CPU is informed to force power mode to be transited to the power saving mode during the deep sleep mode if the battery is almost exhausted.

The second charging mode refers to that the battery of the device is low but not exhausted. If the battery is low, the power management module will inform the control unit to transit the mode to second charging mode while a plug-in signal of the adapter is detected. Under the second charging mode, the CPU and SDRAM could be operated with high speed. Most of the periphery devices in Table one is on except the CODEC. In the first charging mode, the CPU and SDRAM could be operated with high speed. Some of the periphery devices in Table one is on except the DSP, CODEC AND WiFi module.

Other features and description will be described accompany with the drawings.

### BRIEF DESCRIPTION OF THE DRAWINGS

The above objects, and other features and advantages of the present invention will become more apparent after reading the following detailed description when taken in conjunction with the drawings, in which:

FIG. 1 shows power management mode machine diagram according to the present invention.

FIG. 2 shows power management architecture according to the present invention.

Table 1 is a sample for peripheral power mode mapping to every system power mode according to the present invention.

### DETAILED DESCRIPTION OF THE PREFERRED EMBODIMENT

Method and structure for power management is described below. In the following description, numerous specific details are set forth in order to provide a thorough understanding of the present invention, and the scope of the present invention is expressly not limited expect as specified in the accompanying claims.

According to the present invention, the power management module provides the interface to control the power saving for every device driver. Power management module also provides power management events and battery information to user space applications.

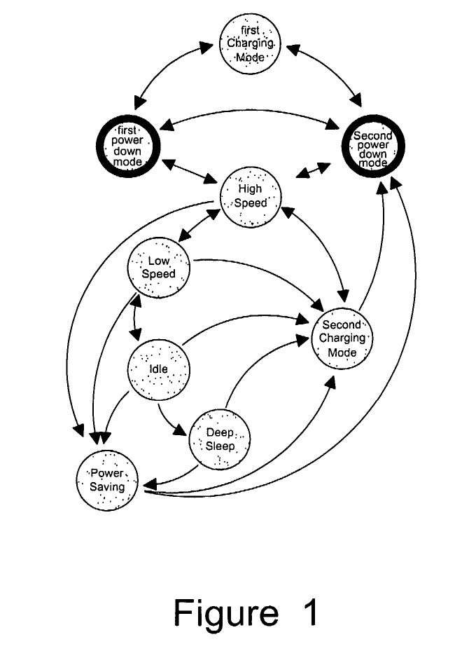

FIG. 1 illustrates the power management mode machine diagram that describes the mode transition for power management mode machine. In the diagram, two charging modes are provided, namely a first charging mode and a second charging mode. The first charging mode will be employed when the battery of the portable device is exhausted, therefore, the device will not be boot while under the operation of first charging mode. Please also refer to the Table 1. During the first charging mode, the CPU and SDRAM could be operated with high speed. The DSP and CODEC are off while the SDRAM, LCD, keypad controller, keypad backlight and RTC are all on. It should be noted that the WiFi module has to be off at the situation if the portable device includes such module.

During the power off mode, please refer to the row 2 (power down) of the Table 1 and FIG. 1, the power management module will transited the power mode to first power down mode. The power of the CPU and other periphery devices will be turn off except the RTC, please refer to Table 1. The first charging mode could be transited from/to the first power down mode or the second power down mode. It could be seen, the power management module may switch between the modes of the first power down mode and high speed mode or between the modes of the second power down mode and the high speed mode. However, the power management module may only switch between the second power down mode and the power saving mode (or the second charging mode). It means that the second charging mode and the power saving mode could be transited from the second power down mode, but the first power down mode is not capable. Thus, during the second power down mode, the CPU is not off, but the speed is reduced from high speed mode to low speed mode.

Please refer to Table 1 again, during the low speed mode, the CPU and SDRAM are operated with low speed that related to the one of high speed operation. The keypad controller and RTC are still power on. Preferably, if the portable device is under the idle mode, the CUP and the SDRAM are operated at low speed, WiFi module is at power saving mode, keypad controller and the RTC are on and other periphery devices in the Table 1 are off. Similarly, in the deep sleep mode, most of the status is similar to the idle mode except that the CUP is suspended and the SDRAM is self-refresh.

During the idle, low speed or high speed stage, if the battery is almost exhausted or low, the power management module informs the CPU to force the power mode to be transited to the power saving mode.

Under the power saving mode, if the battery is almost exhausted, the power management module informs the CPU to force the power mode to be transited to the power down mode, namely, from power saving mode to the second power down mode, as shown in FIG. 1.

In case of that the device is in deep sleep mode while the battery is exhausted, the power management module will inform the CPU to wake up the portable device and to transit from deep sleep mode to the power saving mode, as shown in FIG. 1. No matter under which one situation of high speed, low speed, idle, deep sleep or power saving modes, the power management module may directly or indirectly transit from the current mode to the second charging mode to charge the battery when the portable device detect the plug-in signal of the adapter.

The second charging mode refers to that the battery of the device is low but not exhausted. If the battery is low, the power management module will inform the control unit to transit the mode to the second charging mode while a plug-in signal of the adapter is detected. Under the second charging mode, the CPU and SDRAM could be operated with high speed. Most of the periphery devices in Table one is on except the CODEC. In the first charging mode, the CPU and SDRAM could be operated with high speed. Some of the periphery devices in Table one is on except the DSP, CODEC AND WiFi module.

Please refer to Table 1, the WiFi module is operated at low speed and the LCD is controlled to have a thirty percentage brightness of standard operation.

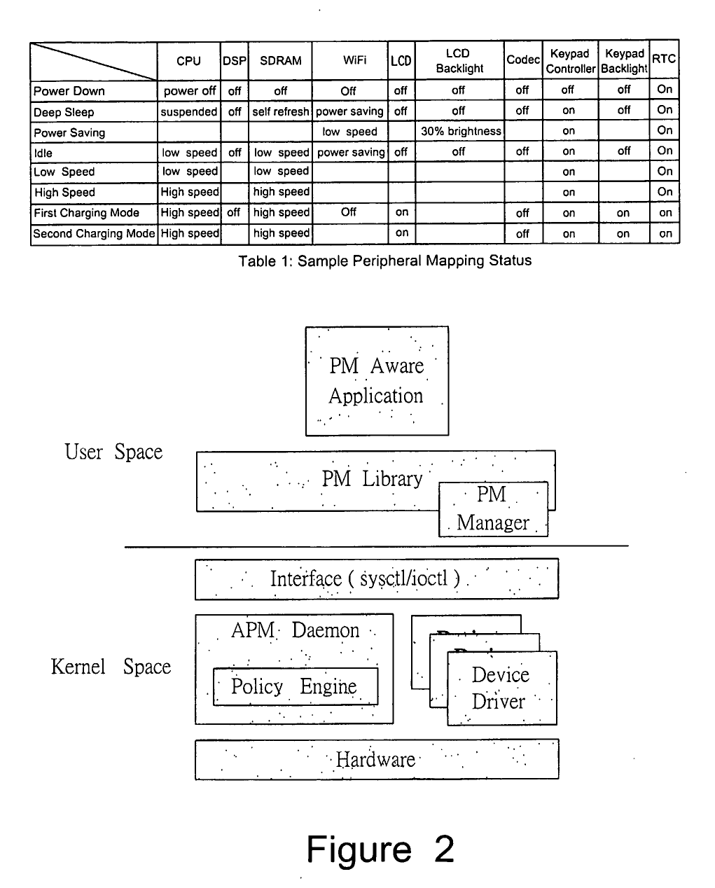

FIG. 2 illustrates the power management architecture according to the present invention. The user space is located over the Kernel space. The user space includes a PM (power management) aware application over a PM library having a PM manager. The Kernel space has an interface over an APM daemon and device driver. The APM daemon includes a policy engine. A hardware is under the APM daemon and device driver.

If a platform has an interface to change its power parameters while platform is running, PM supported kernel for the platform satisfies the following: Kernel follows the APM (advanced power management) standard to implement the power management mechanism. Kernel provides a user space interface to add/remove/modify a power policy. Kernel should provide interfaces to modify the platform's operating mode and power parameters of the platform accordingly. A device driver framework may provide interface to register device constraints on device open and unregister the constraints on device close. When a CPU is idle, kernel should set the CPU at its low power mode if the CPU supports at least one low power mode. The system clocks must be correct regardless of power parameter changes.

APM daemon is run as a kernel space daemon to receive the user space application commands to change the system power mode. APM daemon provides the kernel API interface for device drivers to register for power mode managing.

The policy engine is running in kernel space and the policy engine has to monitor the system loading periodically (usually one second) then changes the system performance dynamically. Further, the policy engine follows the device performance constraint to let the system performance is suitable for those active devices.

PMM is implemented as a user space daemon. PMM provides the communication interface using UNIX socket to let user space application to register. DCL (device control layer) provides APIs set to simply the applications communicate with PMM.

PM-aware (PMA) application will register itself to PMM. PMM sends system suspend request to all applications registered as PMA application. PM-aware application will respond to the system suspend request from PMM appropriately. If PMA application agrees to system suspend, it invokes its suspend handler. The suspend handler may store important data including user data to a non-volatile storage and the suspend handler sends acknowledgement to PMM and waits until it receives resume request from PMM. If PMA application disagrees to system suspend, it sends negative acknowledgement to PMM. If system inactivity which is longer than system timeout threshold is detected, PMM sends system suspend request to PMA applications and wait for responses from EA applications. The PMM provides user interface for initializing the system timeout threshold. The PMM initializes system timeout threshold to a default value. PMM checks device inactivity by periodically reading last access time of device. If a user has requested system suspend, PMM enforces every PMA application to suspend itself and wait for responses from PMA applications. An PMA application which is enforced to suspend by PMM invokes its suspend handler unconditionally.

If a platform device that supports device suspend/resume actions, then both kernel programmatic interfaces and user space interfaces is provided to individually perform device suspend and device resume for only that device. These interfaces suspend other devices that depend upon the selected device for correct operation. Other devices do not depend upon the selected device for correct operation is not suspended or resumed by these interfaces.

If a platform device supports a device suspend mode, or if any actions are needed in order to correctly resume device operation after a system resume from at least one system suspend mode supported by the Linux kernel, then the driver for the device implements the support necessary for the device suspend and resume interfaces. If a platform device supports one device suspend mode, then the device suspend processing performed by the driver for the device is capable of causing the device to enter the supported device suspend mode. Where multiple device suspend modes are available, the driver is capable of entering each of these modes. The device resume processing performed by the driver for a platform device restores device operation to approximate pre-suspend conditions.

The drivers place devices into low-power mode s when not in use or after a period of inactivity. The drivers and platform support code make use of hardware features to automatically place devices into lower-power modes, such as to stop clocks (sometimes referred to as “automatic clock gating”), after a period of inactivity or when the hardware is in some manner able to detect that the device is not in use. DCL implements the interface to change CPU voltage/clock, memory address/data buses and peripheral buses, if a platform supports those features. DCL provides the interface to set the system performance changing parameters, likes the increasing/decreasing frequency range, best performance or best power saving mode. DCL passes the policy parameters to policy engine.

Although specific embodiments have been illustrated and described, it will be obvious to those skilled in the art that various modifications may be made without departing from what is intended to be limited solely by the appended claims.

1. A method of creating a barrier to fluid flow in discrete structures in at least one direction, one said barrier embedded within porous material in each discrete structure, each discrete structure incorporating a porous topmost section, said topmost section emplaced on top of sections of said barrier as a flowable mixture that hardens upon curing, said topmost section being of approximately the same composition as an underlayment immediately below said sections of barrier in each said discrete structure, comprising:
applying to the top surface of said underlayment of each said discrete structure at least one layer of adhesive material, said at least one layer of said adhesive material to include a topmost layer of said adhesive material, said applying done to said top surface of said underlayment of each said discrete structure prior to emplacing said topmost section for each said discrete structure;
placing said sections of barrier onto each said topmost layer of said adhesive material on each said discrete structure said sections of barrier overlapping along edges of other said sections of barrier to establish a continuous array of said sections over each said discrete structure, each said section of barrier incorporating at least one layer of non-porous material, each said section of barrier having a total thickness less than about six mm,
wherein each said array on each said discrete structure covers said topmost layer of said adhesive material on each said discrete structure;
sealing all said overlapped edges of said sections of barrier on each said discrete structure; and
emplacing each said topmost section of each said discrete structure upon said array such that each said array is confined below said topmost section and above said topmost layer of said adhesive material for each said discrete structure.

2. The method of claim 1 providing said section of barrier as a first perforated plate abutted about its entire surface area to a second solid plate, each said first and second plates being of a total thickness of less than about 3 mm.

3. The method of claim 2 employing said first plate immediately adjacent the bottom side of said topmost section.

4. The method of claim 1 providing said sections of barrier as at least one foil of a thickness less than about 1 mm.

5. The method of claim 4 said foil comprising a first perforated foil abutted about its entire surface area to a second solid foil, said first and second foils being of a total thickness of less than about 2 mm.

6. The method of claim 5 employing said first perforated foil immediately adjacent the bottom side of said topmost section.

7. The method of claim 1 incorporating at least one expansion joint at edges of each said discrete structure that abut another said discrete structure, said expansion joint in operable communication with abutting sides of adjoining said discrete structures and abutting said underlayment, said adhesive, said section of barrier and said topmost section of each said discrete structure along said abutting edges of said adjoining discrete structures said expansion joint further comprising a non-porous expandable strip that is placed under each said section of barrier at said abutting edges of said adjoining discrete structures to establish an overlap along the entire length of each side of said section of barrier along said abutting edges of each said discrete structure and below said section of barrier, each said overlap of a width less than about 5.0 cm,
wherein said strip is sealed along each longitudinal edge of said strip between said strip and the bottom of each said section of barrier abutting said edges with a continuous bead of sealant along the entire length of said edges, said sealant remaining flexible upon cure.

8-28. (canceled)
